(19) United States
(12) Patent Application Publication
(10) Pub. No.: US 2024/0404492 A1
(43) Pub. Date: Dec. 5, 2024

(54) DRUM STAND AND DRUM KIT

(71) Applicant: YAMAHA CORPORATION, Hamamatsu-shi (JP)

(72) Inventor: Hiromu SATO, Hamamatsu-shi (JP)

(21) Appl. No.: 18/669,963

(22) Filed: May 21, 2024

(30) Foreign Application Priority Data
May 30, 2023 (JP) 2023-088756

(51) Int. Cl. G10D 13/10

(52) U.S. Cl. CPC G10D 13/28

(57) ABSTRACT

A drum stand includes: a supporting post; and a plurality of arms configured to support a drum. At least one arm, among the plurality of arms, is rotatable relative to the supporting post between a first support position and a second support position. At the first support position, the at least one arm extends outwardly relative to the supporting post. In the second support position, the at least one arm extends outwardly relative to the supporting post is configured to support the drum differently from that at the first support position. A drum kit includes a drum and the drum stand.

### CROSS-REFERENCE TO RELATED APPLICATIONS

The present application claims priority to Japanese Patent Application No. 2023-88756, filed May 30, 2023, the contents of which are incorporated herein by reference.

### BACKGROUND

### Technical Field

The present disclosure relates to a drum stand and drum kit.

### Background Art

Japanese Unexamined Patent Application, First Publication No. 2015-161821 (hereinafter referred to as Patent Document 1) discloses a drum stand for arranging a drum at a predetermined height position. The drum stand has a supporting post, and a plurality of arms that extend radially from the supporting post and support a drum. In the drum stand of Patent Document 1, the length of the first arm is variable, and the second arm is rotatable in the circumferential direction of the supporting post so as to open and close with respect to the first arm. Thereby, it is possible to switch to a plurality of manners in which a drum is supported by a plurality of arms. Specifically, by changing the length of the first arm and changing the rotational position of the second arm with respect to the first arm, a drum of various diameters can be supported by the plurality of arms.

### SUMMARY

However, with the drum stand of Patent Document 1, the operation to switch the manner of supporting the drum is cumbersome. Specifically, such an operation involves adjusting and maintaining the length of the first arm to and at an appropriate length, and adjusting and fixing the rotational position of the second arm to and at a predetermined position, and this makes the operation cumbersome.

The present disclosure takes into consideration the above circumstances, with an object of providing a drum stand and a drum kit capable of easily switching the manner of supporting a drum.

An aspect of the present disclosure is a drum stand including: a supporting post; and a plurality of arms configured to support a drum. At least one arm, among the plurality of arms, is rotatable relative to the supporting post between a first support position and a second support position. At the first support position, the at least one arm extends outwardly relative to the supporting post. In the second support position, the at least one arm extends outwardly relative to the supporting post is configured to support the drum differently from that at the first support position.

Another aspect of the present disclosure is a drum kit including a drum and the above-mentioned drum stand.

### BRIEF DESCRIPTION OF THE DRAWINGS

FIG. 1 is a perspective view of a drum stand according to a first embodiment of the present disclosure, showing a state in which a plurality of arms are each arranged at a first support position.

FIG. 2 is a top view of the drum stand according to the first embodiment of the present disclosure, showing a state in which the plurality of arms are each arranged at the first support position.

FIG. 3 is a perspective view of the drum stand according to the first embodiment of the present disclosure, showing a state in which the plurality of arms are each arranged at a second support position.

FIG. 4 is a top view of the drum stand according to the first embodiment of the present disclosure, showing a state in which the plurality of arms are each arranged at the second support position.

FIG. 5 is a perspective view of the drum stand according to the first embodiment of the present disclosure, showing a state in which the plurality of arms are each arranged at a storage position.

FIG. 6 is a perspective view of the arm of the drum stand according to the first embodiment of the present disclosure, showing an enlarged view of a distal end part of the arm, with the arm being arranged at the first support position.

FIG. 7 is a perspective view of the arm of the drum stand according to the first embodiment of the present disclosure, showing an enlarged view of a distal end part of the arm, with the arm being arranged at the second support position.

FIG. 8 is a diagram showing a modified example of a hook.

FIG. 9 is a perspective view of a drum mounting part of a drum stand according to a second embodiment of the present disclosure, showing a state in which a plurality of arms are each arranged at the first support position.

FIG. 10 is a perspective view of the drum mounting part of the drum stand according to the second embodiment of the present disclosure, showing a state in which the plurality of arms are each arranged at the second support position.

FIG. 11 is a perspective view of a drum stand according to a third embodiment of the present disclosure, showing a state in which a plurality of arms are each arranged at the first support position.

FIG. 12 is a perspective view of the drum stand according to the third embodiment of the present disclosure, showing a state in which the plurality of arms are each arranged at a midway position from the first support position to the storage position.

FIG. 13 is a perspective view of the drum stand according to the third embodiment of the present disclosure, showing a state in which the plurality of arms are each arranged at the storage position.

FIG. 14 is a top view of a drum stand according to a fourth embodiment of the present disclosure, showing a state in which the plurality of arms are each arranged at the first support position.

FIG. 15 is a top view of the drum stand according to the fourth embodiment of the present disclosure, showing a state in which the plurality of arms are each arranged at the second support position.

### DETAILED DESCRIPTION OF THE INVENTION

### First Embodiment

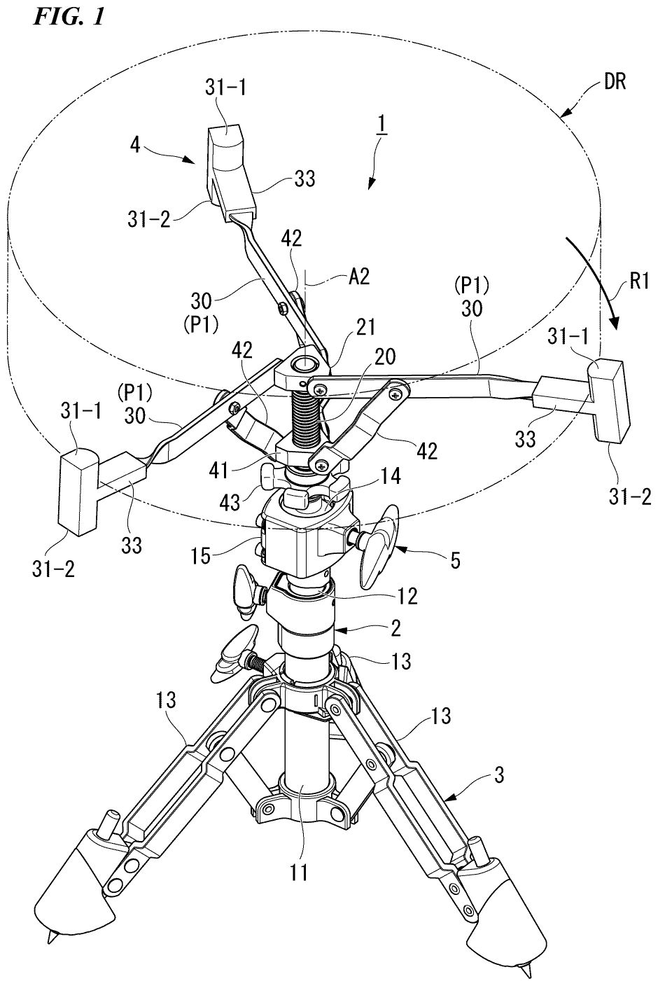

Hereinafter, a first embodiment of the present disclosure will be described, with reference to FIG. 1 to FIG. 7.

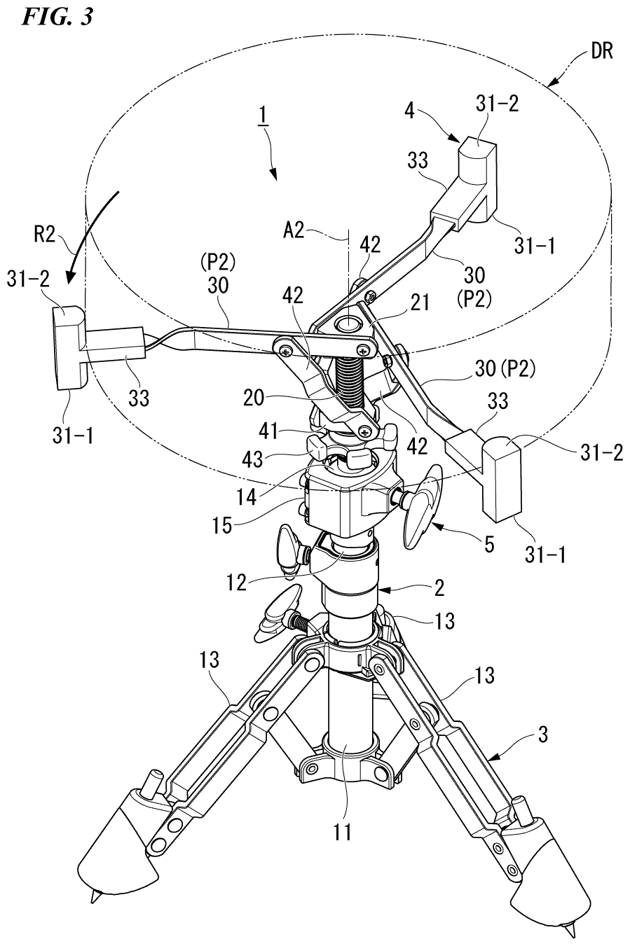

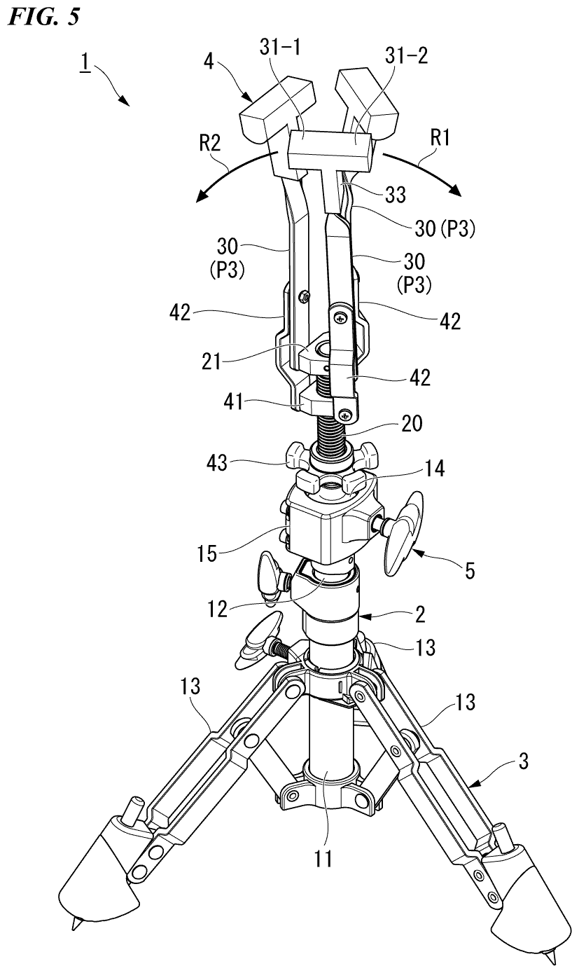

As shown in FIG. 1, FIG. 3, and FIG. 5, a drum stand 1 of the present embodiment includes a stand supporting post 2, a leg part 3 provided at the lower part of the stand supporting post 2, and a drum mounting part 4 provided at the upper part of the stand supporting post 2. A drum kit includes the drum stand 1 and a drum DR.

The stand supporting post 2 is composed of a plurality of (two in the example shown in the drawings) pipes 11, 12. Thereby, the length of the stand supporting post 2 can be adjusted. It should be noted that the stand supporting post 2 may be composed of only one pipe, for example.

As shown in FIG. 1 to FIG. 5, the leg part 3 has a plurality of (three in the example shown in the drawings) legs 13. The plurality of legs 13 are arranged in the circumferential direction of the stand supporting post 2 and are foldable relative to the stand supporting post 2. The leg part 3 supports the stand supporting post 2 so that the stand supporting post 2 extends in the up-down direction with the plurality of legs 13 expanded relative to the stand supporting post 2 (see FIG. 1, FIG. 3, and FIG. 5 in particular).

As shown in FIG. 1, FIG. 3, and FIG. 5, the drum mounting part 4 is provided on the upper part of the stand supporting post 2 via an angle adjustment mechanism 5. The angle adjustment mechanism 5 sets the drum mounting part 4 to an arbitrary angular posture with respect to the stand supporting post 2. The specific configuration of the angle adjustment mechanism 5 may be arbitrary. The angle adjustment mechanism 5 of the present embodiment is configured with a ball clamp having a spherical body 14 and a retainer part 15. The spherical body 14 is provided at the lower end of a mounting supporting post 20 of the drum mounting part 4, which will be described later. The retainer part 15 is provided at the upper end of the stand supporting post 2, and rotatably holds the spherical body 14. Moreover, the retainer part 15 is configured to be able to switch between a state of allowing the spherical body 14 to rotate and a state of not allowing the spherical body 14 to rotate.

As shown in FIG. 1 to FIG. 5, the drum mounting part 4 includes the mounting supporting post 20 (supporting post) and a plurality of arms 30 that support the drum DR. Moreover, the drum mounting part 4 includes a link base 41, a plurality of arm links 42, and an adjustment nut 43.

An arm attachment part 21 for attaching the plurality of arms 30 is provided at the upper end of the mounting supporting post 20.

The arm attachment part 21 of the present embodiment is formed in a regular polygonal block shape when viewed from the axial direction of the mounting supporting post 20. When viewed from the axial direction of the mounting supporting post 20, the center of the regular polygon of the arm attachment part 21 is positioned to coincide with an axis A2 of the mounting supporting post 20, or to be slightly shifted from the axis A2. The number of angles (number of sides) of the regular polygonal shape in the arm attachment part 21 corresponds to the number of arms 30.

A male thread is formed on the outer periphery of the mounting supporting post 20.

As shown in FIG. 1 to FIG. 4, the plurality of arms 30 support the drum DR while extending radially from the mounting supporting post 20 when viewed from the axial direction of the mounting supporting post 20. In other words, when supporting the drum DR, the plurality of arms 30 each extend in the radial directions from the mounting supporting post 20 and are lined up in the circumferential direction of the mounting supporting post 20.

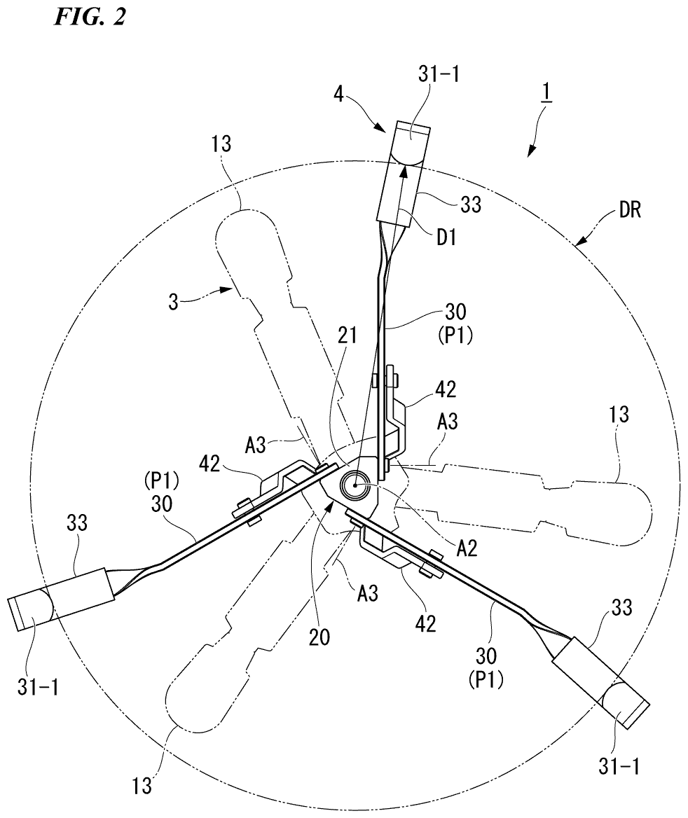

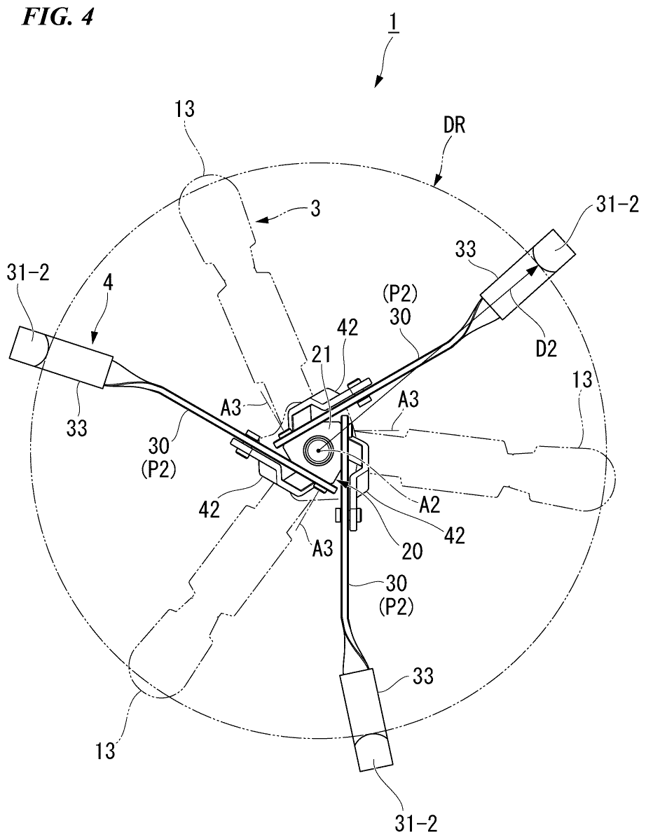

The plurality of arms 30 have a first support position P1 shown in FIG. 1 and FIG. 2, and a second support position P2 shown in FIG. 3 and FIG. 4. The plurality of arms 30 also have a storage position P3 shown in FIG. 5. As shown in FIG. 1 to FIG. 4, both the first support position P1 and the second support position P2 are positions such that, when viewed from the axial direction of the mounting supporting post 20, the plurality of arms 30 each extend in the radial direction of the mounting supporting post 20 to support the drum DR. However, at the first support position P1 and at the second support position P2 the arms 30 extend from the mounting supporting post 20 in different manners as will be described later. The plurality of arms 30 are each rotatably attached to the mounting supporting post 20 between the first support position P1 and the second support position P2.

As shown in FIG. 5, the storage position P3 is a position where the plurality of arms 30 each extend in the axial direction of the mounting supporting post 20. As a result of rotating in a first rotation direction R1 relative to the storage position P3, each of the plurality of arms 30 is arranged at the first support position P1 shown in FIG. 1 and FIG. 2. Also, as a result of rotating relative to the storage position P3 in a second rotation direction R2 opposite to the first rotation direction R1, each of the plurality of arms 30 is arranged at the second support position P2 shown in FIG. 3 and FIG. 4. FIG. 1, FIG. 3, and FIG. 5 show the first rotation direction R1 and the second rotation direction R2 of one arm 30.

As shown in FIG. 2 and FIG. 4, the rotational axis A3 of each arm 30 that rotates relative to the mounting supporting post 20 is orthogonal to the axis A2 of the mounting supporting post 20. The rotational axes A3 of the plurality of arms 30 are arranged at equal intervals in the circumferential direction around the axis A2 of the mounting supporting post 20. Thereby, the plurality of arms 30 are arranged at equal intervals in the circumferential direction of the mounting supporting post 20.

Hereinafter, the manner in which the plurality of arms 30 are attached to the mounting supporting post 20 will be described in more detail. The proximal end part in the lengthwise direction of each of the plurality of arms 30 is rotatably attached to the arm attachment part 21 of the mounting supporting post 20. The proximal end part of each arm 30 is arranged to overlap the side surface of the arm attachment part 21 the lengthwise direction of which forms a side of a regular polygon and extends in the axial direction of the mounting supporting post 20. Each arm 30 is rotatable relative to the arm attachment part 21 around the rotational axis A3 orthogonal to the side surface of the arm attachment part 21 on which the proximal end part thereof is arranged. Each arm 30 extends along the sides of the regular polygon of the arm attachment part 21 while being arranged at the first support position P1 or the second support position P2 (see FIG. 2 and FIG. 4 in particular). The plurality of arms 30 are arranged to overlap side surfaces of the arm attachment part 21 corresponding to different sides of the regular polygon in the arm attachment part 21.

In this state, each arm 30 is positioned so as not to overlap the mounting supporting post 20 when viewed from the lengthwise direction of the arm 30. Thereby, even when the arm 30 rotates between the first support position P1 and the second support position P2 via the storage position P3, the arm 30 will not interfere with the mounting supporting post 20.

As shown in FIG. 1 and FIG. 3, the plurality of arms 30 each have a hook 31 (31-1, 31-2). The hook 31 is located at the distal end part of the arm 30 remote from the mounting supporting post 20. The hooks 31 of the plurality of arms 30 grip the drum DR while the plurality of arms 30 are arranged at the first support position P1 and at the second support position P2.

The hook 31 of each arm 30 include a first hook 31-1 and a second hook 31-2. The first hook 31-1 and the second hook 31-2 project from the distal end part of the arm 30 in opposite directions to each other. The first hook 31-1 and the second hook 31-2 are positioned without shifting from each other in the lengthwise direction of the arm 30.

As shown in FIG. 1, the first hook 31-1 protrudes generally upward from the distal end part of the arm 30 when the arm 30 is arranged at the first support position P1. As a result, when the plurality of arms 30 are arranged at the first support position P1, the first hooks 31-1 of the plurality of arms 30 grip the drum DR. As shown in FIG. 3, the second hook 31-2 protrudes generally upward from the distal end part of the arm 30 when the arm 30 is arranged at the second support position P2. As a result, when the plurality of arms 30 are arranged at the second support position P2, the second hooks 31-2 of the plurality of arms 30 grip the drum DR.

As shown in FIG. 1 and FIG. 3, each of the plurality of arms 30 has a supporting part 33. The supporting part 33 makes contact with and supports the drum DR when the arms 30 are arranged at the first support position P1 and the second support position P2. The supporting part 33 of the present embodiment is located at the distal end part of the arm 30 and includes the hook 31 described above.

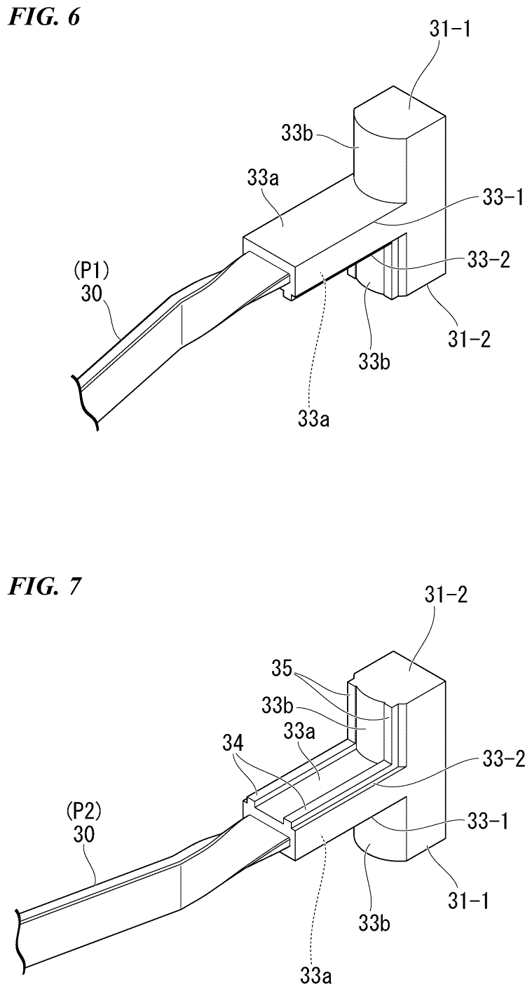

As shown in FIG. 6 and FIG. 7, the supporting part 33 (33-1, 33-2) has a supporting bottom surface 33a that comes in contact with the lower part of the drum DR, and a supporting side surface 33b that also serves as a hook 31 and comes in contact with the side part of the drum DR. The supporting part 33 may be made of rubber or the like.

The supporting part 33 includes a first supporting part 33-1 and a second supporting part 33-2. The first supporting part 33-1 makes contact with and supports the drum DR, with the arm 30 arranged at the first support position P1. The second supporting part 33-2 makes contact with and supports the drum DR, with the arm 30 arranged at the second support position P2.

As shown in FIG. 1, FIG. 3, and FIG. 5, the mounting supporting post 20 penetrates through the link base 41. The link base 41 is movable relative to the mounting supporting post 20 between its upper end and lower end.

The adjustment nut 43 has a female thread (not shown in the drawings) that meshes with the male thread of the mounting supporting post 20. The adjustment nut 43 is arranged between the link base 41 and the lower end of the mounting supporting post 20, and supports the link base 41. The adjustment nut 43 is movable in the axial direction of the mounting supporting post 20 by rotating relative to the mounting supporting post 20.

The number of arm links 42 corresponds to the number of arms 30. A first end part in the lengthwise direction of each arm link 42 is rotatably attached to an arbitrary portion of the arm 30 except the proximal end part thereof (in the example shown in the drawings, a midway part in the lengthwise direction of the arm 30). A second end part of the arm link 42 in the lengthwise direction is rotatably attached to the link base 41. Therefore, each of the plurality of arms 30 is connected to the link base 41 via the arm link 42. As a result, the plurality of arms 30 all rotate in conjunction with each other between the first support position P1 and the second support position P2. In other words, the plurality of arms 30 do not rotate independently of each other. When the plurality of arms 30 are arranged at the first support position P1 or at the second support position P2, the adjustment nut 43 supports the link base 41. This prevents the arms 30 from further moving in the first rotation direction R1 from the first support position P1, and the arms 30 from further moving in the second rotation direction R2 from the second support position P2.

In the drum mounting part 4 of the present embodiment, in each arm 30, the length from the rotational axis A3 of the arm 30 to the first hook 31-1 is the same as that to the second hook 31-2. Moreover, among the plurality of arms 30, the lengths from the rotational axes A3 of the arms 30 to the hooks 31 are the same.

On the other hand, as shown in FIG. 2 and FIG. 4, the rotational axis A3 of each arm 30 is orthogonal to but not intersecting with the axis A2 of the mounting supporting post 20. The rotational axis A3 of each arm 30 is located offset from the middle of the sides of the regular polygon corresponding to the position intersecting with the axis A2 of the mounting supporting post 20 when viewed from the axial direction of the mounting supporting post 20. As a result, in each arm 30, when viewed from the axial direction of the mounting supporting post 20, the distances D1, D2 from the axis A2 of the mounting supporting post 20 to the hooks 31 of the arm 30 at the first support position is not the same as that at the second support position P2. That is to say, the plurality of arms 30 extend in the radial directions of the mounting supporting post 20 from the mounting supporting post 20 in mutually different manners at the first support position P1 and at the second support position P2.

More specifically, in each of the plurality of arms 30, the rotational axis A3 of the arm 30 is offset from the position where it would intersect with the axis A2 of the mounting supporting post 20, in the direction toward the distal end part from the proximal end part of the arm 30 when the arm 30 is arranged at the first support position P1 (see FIG. 2). The amount of offset of the rotational axis A3 of the arm 30 with respect to the axis A2 of the mounting supporting post 20 is the same for all of the plurality of arms 30. As a result, the first distance D1 from the axis A2 of the mounting supporting post 20 to the hook 31 of each arm 30 when the plurality of arms 30 are arranged at the first support position P1 (FIG. 2) becomes longer than the second distance D2 from the axis A2 of the mounting supporting post 20 to the hook 31 of each arm 30 when the plurality of arms 30 are arranged at the second support position P2 (FIG. 4).

The first distance D1 and the second distance D2 correspond to the diameters of drums DR that can be held by the plurality of arms 30. That is to say, by switching the plurality of arms 30 between the first support position P1 and the second support position P2, it is possible to grip drums DR with different diameters.

Furthermore, in the drum mounting part 4 of the present embodiment, as shown in FIG. 6, the supporting bottom surface 33a of the first supporting part 33-1 is a flat surface. Moreover, the supporting side surface 33b of the first supporting part 33-1 is a bulging surface the central portion of which bulges taller than both end parts thereof in the widthwise direction. On the other hand, as shown in FIG. 7, the supporting bottom surface 33a of the second supporting part 33-2 includes a flat surface, and two protruding parts 34 that protrude from both ends of the flat surface in the widthwise direction and extend in the lengthwise direction of the arm 30. Also, the supporting side surface 33b of the second supporting part 33-2 includes a bulging surface the central part of which bulges taller than both end parts in the widthwise direction, and two protruding parts 35 that protrude from both ends of the bulging surface in the widthwise direction and extend in the projecting direction of the second hook 31-2. In other words, the aspect of the supporting bottom surface 33a and the supporting side surface 33b of the first supporting part 33-1 is different from the aspect of the supporting bottom surface 33a and the supporting side surface 33b of the second supporting part 33-2. For this reason, the manner in which the first supporting part 33-1 makes contact with and supports the drum DR when the plurality of arms 30 are arranged at the first support position P1 is different from the manner in which the second supporting part 33-2 makes contact with and supports the drum DR when the plurality of arms 30 are arranged at the second support position P2. That is to say, the characteristics of supporting a drum DR becomes different between the first supporting part 33-1 and the second supporting part 33-2. As a result of the difference between the first supporting part 33-1 and the second supporting part 33-2, the plurality of arms 30 extend in the radial directions of the mounting supporting post 20 from the mounting supporting post 20 in mutually different manners at the first support position P1 and at the second support position P2.

As explained above, in the drum stand 1 of the first embodiment, the plurality of arms 30 extend in the radial directions of the mounting supporting post 20 from the mounting supporting post 20 in mutually different manners at the first support position P1 and at the second support position P2. Moreover, the plurality of arms 30 are rotatably attached to the mounting supporting post 20 between the first support position P1 and the second support position P2. In other words, by simply rotating the plurality of arms 30 relative to the mounting supporting post 20, the arms 30 can be arranged at two positions, the first support position P1 and the second support position P2. That is to say, the drum stand 1 has two manners of supporting a drum DR. As a result, the manner in which a drum DR is supported by the drum stand 1 can be easily switched.

Moreover, in the drum stand 1 of the first embodiment, the plurality of arms 30 are each arranged at the first support position P1 by rotating them in the first rotation direction R1 relative to the mounting supporting post 20 from the storage position P3. Furthermore, the plurality of arms 30 are each arranged at the second support position P2 by rotating them in the second rotation direction R2 from the storage position P3. Thus, the manner in which a drum DR is supported by the drum stand 1 can be easily switched by simply rotating the plurality of arms 30 in opposite directions relative to the storage position P3.

Moreover, in the drum stand 1 of the first embodiment, the plurality of arms 30 are each positioned so as not to overlap the mounting supporting post 20 when viewed from the lengthwise direction of the arm 30. Thereby, even when the arm 30 rotates between the first support position P1 and the second support position P2 via the storage position P3, it is possible to prevent the arm 30 from interfering with the mounting supporting post 20. In other words, the arm 30 can be reliably rotated between the first support position P1 and the second support position P2.

Moreover, in the drum stand 1 of the first embodiment, when viewed from the axial direction of the mounting supporting post 20, the distances D1, D2 from the mounting supporting post 20 to the hook 31 of each arm 30 are different between the first support position P1 and the second support position P2. As a result, by switching the plurality of arms 30 between the first support position P1 and the second support position P2, it is possible to grip drums DR with different diameters.

Moreover, in the drum stand 1 of the first embodiment, the rotational axes A3 of the plurality of arms 30 are each orthogonal to but not intersecting with the axis A2 of the mounting supporting post 20. As a result, the distances D1 and D2 from the mounting post 20 to the hook 31 of the arm 30 can be reliably made different between the first support position P1 and the second support position P2.

Moreover, in the drum stand 1 of the first embodiment, the plurality of arms 30 each have the first supporting part 33-1 that makes contact with and supports the drum DR when the arm 30 is arranged at the first support position P1, and the second supporting part 33-2 that makes contact with and supports the drum DR when the arm 30 is arranged at the second support position P2. Also, the first supporting part 33-1 and the second supporting part 33-2 have different characteristics of supporting a drum DR. That is to say, the manner in which a drum DR is supported is different between the first supporting part 33-1 and the second supporting part 33-2. As a result, by supporting the drum DR by either the first supporting part 33-1 or the second supporting part 33-2, it is possible to change the characteristics of sound generated by the drum DR (for example, tone color and tone duration (sustain)).

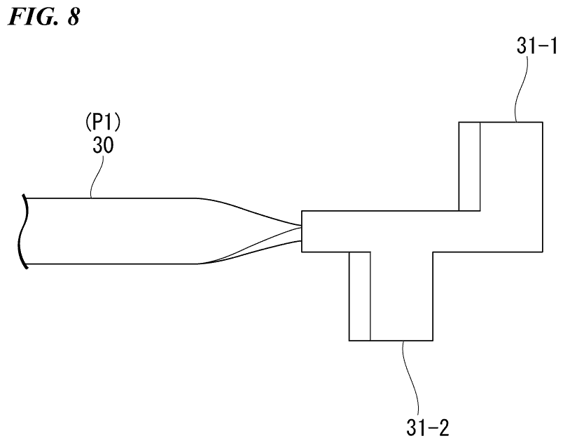

In the first embodiment, the specific configuration in which the distances D1, D2 from the axis A2 of the mounting supporting post 20 to the hook 31 are made different between the first support position P1 and the second support position P2 may be as follows. For example, as shown in FIG. 8, the first hook 31-1 and the second hook 31-2 in each arm 30 may be arranged at different positions in the lengthwise direction of the arm 30. In such a configuration, even if the rotational axis A3 of each arm 30, which is orthogonal to the axis A2 of the mounting supporting post 20, intersects with the axis A2 of the mounting supporting post 20, the distances D1, D2 from the axis A2 of the mounting supporting post 20 to the hook 31 can be made different between the first support position P1 and the second support position P2.

In the first embodiment, the specific configuration in which the first support portion 33-1 and the second support portion 33-2 have different characteristics for supporting a drum DR is not limited to the configuration exemplified in FIG. 6 and FIG. 7. For example, the first supporting part 33-1 and the second supporting part 33-2 may each have a different elasticity. Even with such a configuration, as in the case of the first embodiment, by supporting the drum DR by either the first supporting part 33-1 or the second supporting part 33-2, it is possible to change the characteristics of sound generated by the drum DR (for example, tone color and tone duration (sustain)).

The configuration in which the first supporting part 33-1 and the second supporting part 33-2 have different characteristics for supporting a drum DR may be applied to a configuration, for example, in which drums DR of the same diameter are gripped at the first support position P1 and the second support position P2.

According to the drum kit of the first embodiment, advantageous effects similar to the drum stand of the first embodiment can be achieved.

### Second Embodiment

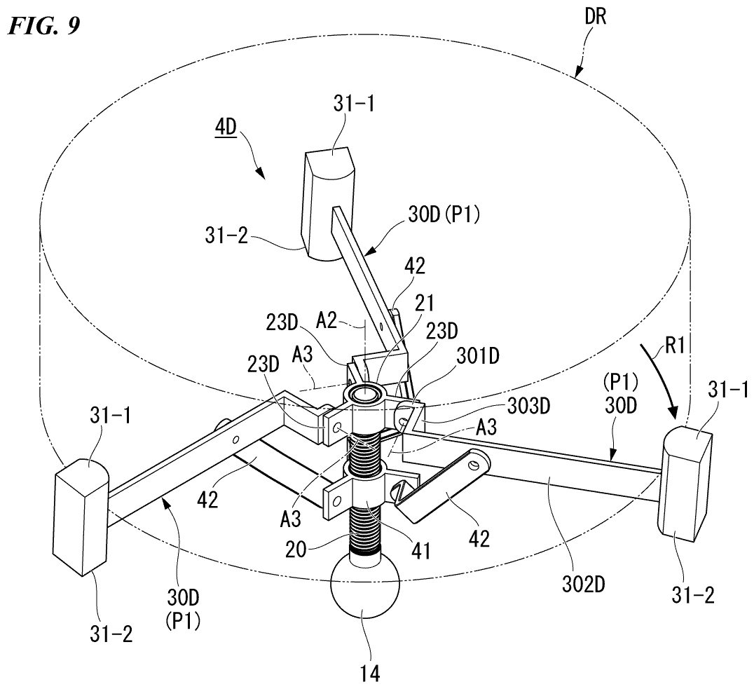

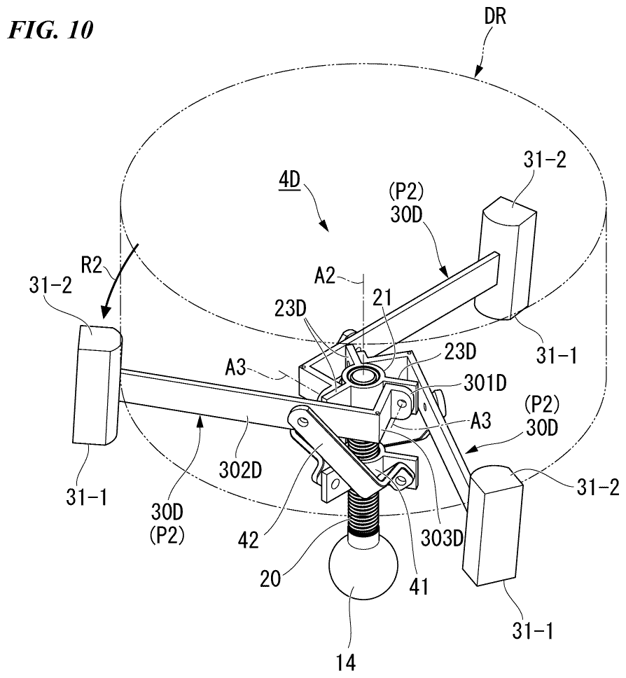

Hereinafter, a second embodiment of the present disclosure will be described, with reference to FIG. 9 and FIG. 10. In the following description, the components that have already been described above are given the same reference signs and redundant description will be omitted.

As shown in FIG. 9 and FIG. 10, a drum stand of the second embodiment has a drum mounting part 4D as with the first embodiment. In FIG. 9 and FIG. 10, the stand supporting post 2, the leg parts 3, and the adjustment nut 43 (see FIG. 1 and so forth) are omitted. A drum kit of the second embodiment includes the drum stand of the second embodiment and the drum DR.

As in the first embodiment, a plurality of arms 30D each have a first support position P1 shown in FIG. 9 and a second support position P2 shown in FIG. 10. Although not shown in the drawings, the plurality of arms 30D also have a storage position P3 (see FIG. 5) as in the first embodiment.

In the second embodiment, an arm attachment part 21 provided at the upper end part of a mounting supporting post 20 has a plurality of mounting plate parts 23D extending toward the outside of the mounting supporting post 20 in the radial direction. The number of mounting plate parts 23D corresponds to the number of arms 30D. The plurality of arms 23D are arranged at equal intervals in the circumferential direction of the mounting supporting post 20. The plate thickness direction of each mounting plate part 23D is oriented in the direction in which the plurality of mounting plate parts 23D are arranged. An arm 30D is rotatably attached to each mounting plate part 23D.

In the second embodiment, each of the plurality of arms 30D has a proximal end part 301D, a distal end side portion 302D, and a connecting part 303D.

The proximal end part 301D of each arm 30D is arranged to overlap the mounting plate part 23D in the thickness direction thereof. Each arm 30D is rotatable relative to the mounting plate part 23D around the rotational axis A3 extending in the plate thickness direction of the mounting plate part 23D at the proximal end part 301D thereof. Therefore, when each arm 30D is arranged at the first and second support positions P1, P2, the proximal end part 301D of each arm 30D overlaps the mounting supporting post 20 as viewed from the lengthwise direction of each arm 30D.

The distal end side portion 302D of each arm 30D is a portion that extends in a direction away from the rotational axis A3 of the arm 30D relative to the proximal end part 301D, and is positioned offset relative to the proximal end part 301D in a direction along the rotational axis A3 of the arm 30D. As a result, the distal end side portion 302D of each arm 30D does not overlap the mounting supporting post 20 when viewed from the lengthwise direction of each arm 30D.

The connecting part 303D of each arm 30D extends from the proximal end part 301D to the distal end side portion 302D along the rotational axis A3 of the arm 30D, connecting the proximal end part 301D and the distal end side portion 302D.

As described above, the distal end side portion 302D of each arm 30D attached to the mounting supporting post 20 is positioned so as not to overlap the mounting supporting post 20 when viewed from the lengthwise direction of the arm 30D. Thereby, even when the arm 30D rotates between the first support position P1 and the second support position P2 via the storage position P3, the arm 30D will not interfere with the mounting supporting post 20.

Moreover, as in the first embodiment, the rotational axis A3 of each arm 30D attached to the mounting supporting post 20 is orthogonal to but not intersecting with the axis A2 of the mounting supporting post 20. As a result, in the second embodiment also, in each arm 30, when viewed from the axial direction of the mounting supporting post 20, the distances from the axis A2 of the mounting supporting post 20 to the hooks 31 (31-1, 31-2) of the arm 30D are not the same at the first support position P1 and the second support position P2.

Specifically, the rotational axis A3 of each arm 30D is positioned offset relative to the axis A2 of the mounting supporting post 20 in the direction toward the distal end part (hook 31) of the arm 30D from the proximal end part 301D when the arm 30D is arranged at the first support position P1. As a result, the first distance from the axis A2 of the mounting supporting post 20 to the hook 31 of each arm 30D when the plurality of arms 30D are arranged at the first support position P1 becomes longer than the second distance from the axis A2 of the mounting supporting post 20 to the hook 31 of each arm 30D when the plurality of arms 30D are arranged at the second support position P2. That is to say, the plurality of arms 30D extend in the radial directions of the mounting supporting post 20 from the mounting supporting post 20 in mutually different manners at the first support position P1 and at the second support position P2.

According to the drum stand and the drum kit of the second embodiment, advantageous effects similar to those of the first embodiment can be achieved.

In the second embodiment, the arm 30D may have, for example, the same supporting parts 33 (first supporting part 33-1, second supporting part 33-2) as in the first embodiment.

In the second embodiment, as exemplified in FIG. 8, the first hook 31-1 and the second hook 31-2 may be arranged at different positions in the lengthwise direction of the arm 30D.

### Third Embodiment

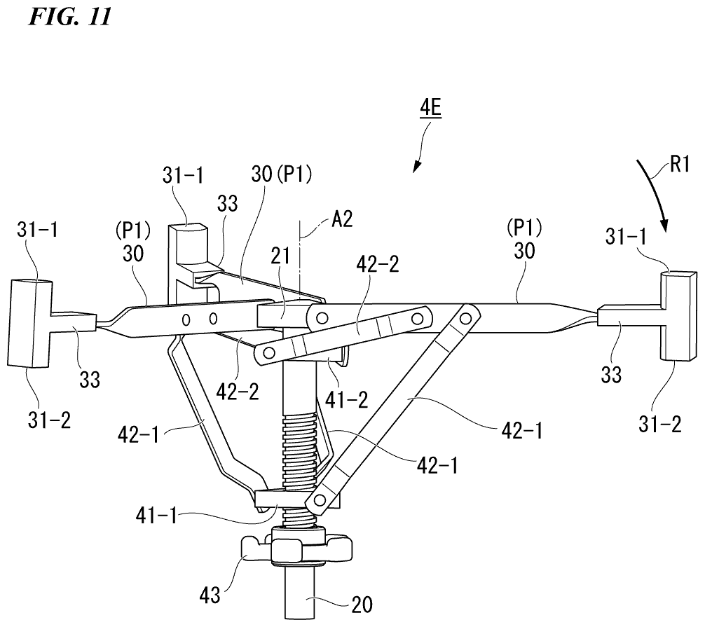

Next, a third embodiment of the present disclosure will be described, with reference to FIG. 11 to FIG. 13. In the following description, the components that have already been described above are given the same reference signs and redundant description will be omitted.

As shown in FIG. 11 to FIG. 13, a drum stand of the third embodiment has a drum mounting part 4E as with the first embodiment. In FIG. 11 to FIG. 13, the stand supporting post 2 and the leg parts 3 (see FIG. 1 and so forth) are omitted. A drum kit of the third embodiment includes the drum stand of the third embodiment and the drum DR.

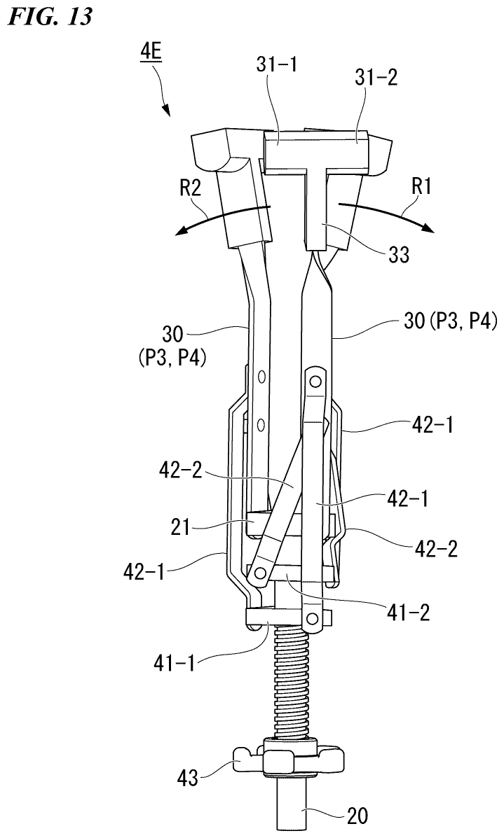

As in the first embodiment, a plurality of arms 30 each have a first support position P1 shown in FIG. 11 and a storage position P3 shown in FIG. 13. Although not shown in the drawings, the plurality of arms 30 also have a second support position P2 (see FIG. 3) as in the first embodiment.

The drum mounting part 4E of the third embodiment includes a first link base 41-1, a plurality of first arm links 42-1, a second link base 41-2, and a plurality of second arm links 42-2. The number of the first arm links 42-1 and second arm links 42-2 both correspond to the number of arms 30.

The mounting supporting post 20 penetrates through each of the first link base 41-1 and the second link base 41-2. The first link base 41-1 and the second link base 41-2 are each movable in the axial direction relative to the mounting supporting post 20.

The plurality of first arm links 42-1 respectively connect the first link base 41-1 and the plurality of arms 30. A first end part in the lengthwise direction of each first arm link 42-1 is rotatably attached to an arbitrary portion of the arm 30 except the proximal end part thereof (in the example shown in the drawings, a midway part in the lengthwise direction of the arm 30). A second end part of the first arm link 42-1 in the lengthwise direction is rotatably attached to the first link base 41-1. Therefore, each of the plurality of arms 30 is connected to the first link base 41-1 via the first arm link 42-1. As a result, the plurality of arms 30 all rotate in conjunction with each other between the first support position P1 and the second support position P2. In other words, the plurality of arms 30 do not rotate independently of each other.

The plurality of second arm links 42-2 respectively connect the second link base 41-2 and the plurality of arms 30. A first end part in the lengthwise direction of each second arm link 42-2 is rotatably attached to an arbitrary portion of the arm 30 except the proximal end part thereof (in the example shown in the drawings, a midway part in the lengthwise direction of the arm 30). A second end part of the second arm link 42-2 in the lengthwise direction is rotatably attached to the second link base 41-2. Therefore, each of the plurality of arms 30 is connected to the second link base 41-2 via the second arm link 42-2. As a result, the plurality of arms 30 all rotate in conjunction with each other between the first support position P1 and the second support position P2. In other words, the plurality of arms 30 do not rotate independently of each other.

The second end part of the first arm link 42-1 and the second end part of the second arm link 42-2 attached to the same arm 30 are arranged at different positions in the circumferential direction of the mounting supporting post 20, that is to say, they are positioned offset from each other in the circumferential direction of the mounting supporting post 20. Therefore, the first arm link 42-1 and the second arm link 42-2 attached to the same arm 30 are not parallel to each other.

In the third embodiment, the first end part of the second arm link 42-2 is positioned closer to the proximal end part of the arm 30 than the first end part of the first arm link 42-1 in the lengthwise direction of the arm 30. However, the disclosure is not limited to this example. The first end part of the second arm link 42-2 may be positioned closer to the distal end part of the arm 30 than the first end part of the first arm link 42-1 in the lengthwise direction of the arm 30, or may be positioned at the same location as the first end part of the arm link 42-1.

As shown in FIG. 13, at a first rotational position P4 of the arm 30 located between the first support position P1 and the second support position P2, the arm 30 and the first arm link 42-1 attached to this arm 30 are parallel. Moreover, at the first rotational position P4 of the arm 30, the arm 30 and the second arm link 42-2 attached to the arm 30 are inclined relative to each other. In the third embodiment, although the first rotational position P4 corresponds to the storage position P3, the disclosure is not limited to this example.

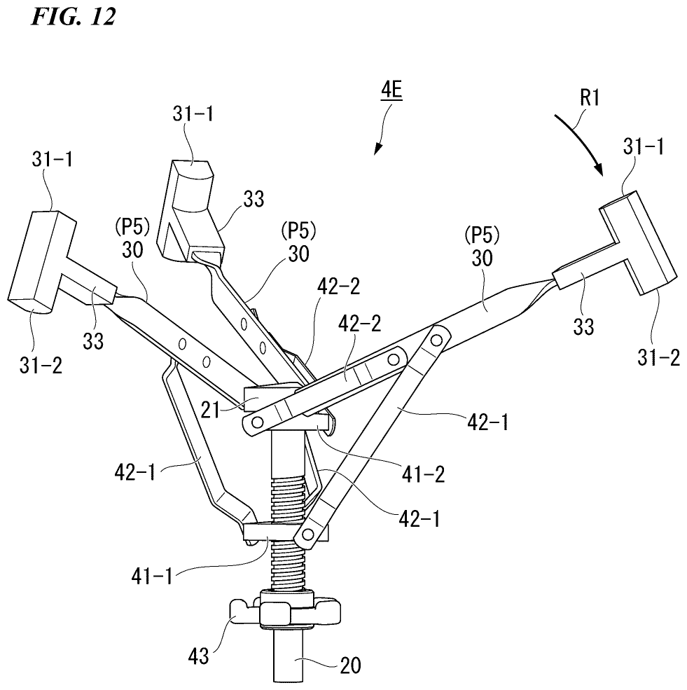

As shown in FIG. 12, at a second rotational position P5 of the arm 30 located between the first support position P1 and the second support position P2, the arm 30 and the second arm link 42-2 attached to this arm 30 are parallel. Moreover, at the second rotational position P5 of the arm 30, the arm 30 and the first arm link 42-1 attached to this arm 30 are inclined relative to each other. In the third embodiment, although the second rotational position P5 is positioned between the first support position P1 and the storage position P3, the disclosure is not limited to this example.

The first rotational position P4 and the second rotational position P5 of the arm 30 described above are different from each other.

In the drum mounting part 4E of the third embodiment configured as described above, as shown in FIG. 11 and FIG. 12, the second link base 41-2 moves upward as the arm 30 rotates from the first support position P1 to the second rotation position P5. Also, as shown in FIG. 12 and FIG. 13, the second link base 41-2 moves downward as the arm 30 further rotates from the second rotational position P5 to the second support position P2. In other words, the second rotational position P5 of the arm 30 corresponds to the dead center position of the second link base 41-2.

On the other hand, as shown in FIG. 11 to FIG. 13, the first link base 41-1 moves upward as the arm 30 rotates from the first support position P1 to the first rotational position P4. Moreover, although not shown in the drawings, the second link base 41-2 moves downward as the arm 30 further rotates from the first rotational position P4 to the second support position P2. That is to say, the first rotational position P4 of the arm 30 corresponds to the dead center position of the first link base 41-1.

According to the drum stand and the drum kit of the third embodiment, advantageous effects similar to those of the first embodiment can be achieved.

Moreover, in the drum stand of the third embodiment, the first rotational position P4 of the arm 30 where the arm 30 and the first arm link 42-1 attached to the arm 30 are parallel, and the second rotational position P5 of the arm 30 where the arm 30 and the second arm link 42-2 attached to the arm 30 are parallel, are different from each other. Therefore, the phases (dead center positions) of the first and second link bases 41-1, 41-2 can be made different. As a result, when the user of the drum stand grips some (for example, two) arms 30 and rotates them between the first support position P1 and the second support position P2, it is possible to suppress or prevent rotation of the arm 30 that is not gripped from being hindered at the dead center of the first link base 41-1 and the second link base 41-2 and in their vicinity (at the first and second rotational positions P4, P5 of the arm 30 and in the vicinity thereof). Therefore, when the user of the drum stand grips some of the arms 30 and rotates them between the first support position P1 and the second support position P2, all of the arms 30 including the arms 30 not gripped can be rotated smoothly.

Moreover, in the drum stand of the third embodiment, the second end part of the first arm link 42-1 and the second end part of the second arm link 42-2 attached to the same arm 30 are arranged at different positions in the circumferential direction of the mounting supporting post 20. As a result, the first rotational position P4 of the arm 30 where the arm 30 and the first arm link 42-1 attached to the arm 30 are parallel, and the second rotational position P5 of the arm 30 where the arm 30 and the second arm link 42-2 attached to the arm 30 are parallel, can be reliably made different from each other. Therefore, when the user grips some of the arms 30 and rotates them between the first support position P1 and the second support position P2, all of the arms 30 including the arms 30 not gripped can be rotated smoothly.

### Fourth Embodiment

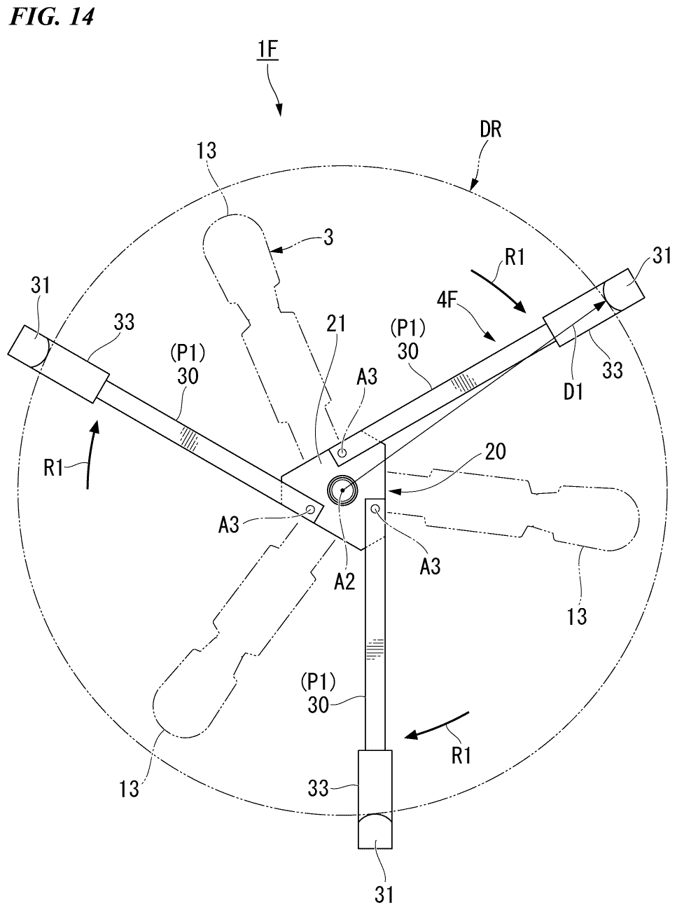

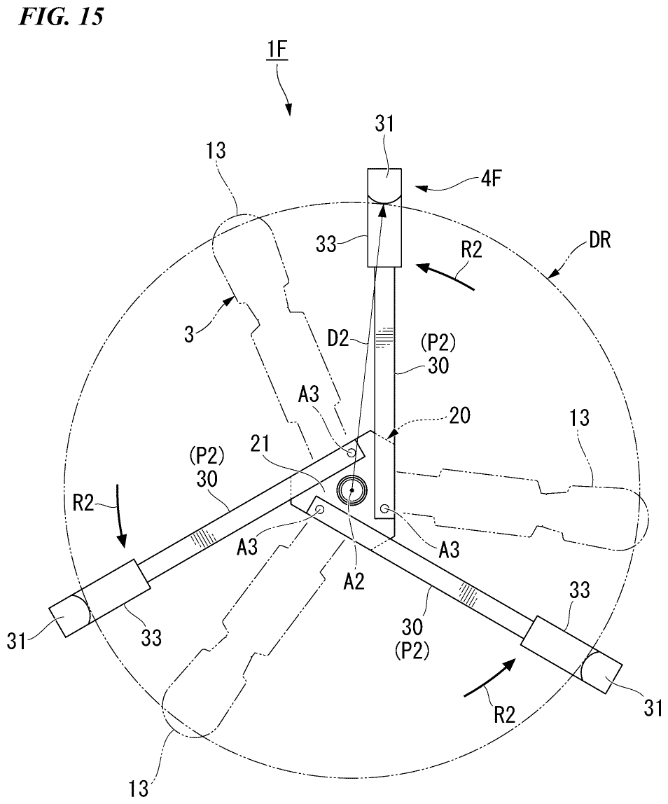

Next, a fourth embodiment of the present disclosure will be described, with reference to FIG. 14 and FIG. 15. In the following description, the components that have already been described above are given the same reference signs and redundant description will be omitted.

As shown in FIG. 14 and FIG. 15, a drum stand 1F of the fourth embodiment has a drum mounting part 4F and a leg part 3 as with the first embodiment. In FIG. 14 and FIG. 15, the stand supporting post 2 of the drum stand 1F (see FIG. 1 and so forth) is omitted. A drum kit of the fourth embodiment includes the drum stand of the fourth embodiment and the drum DR.

As in the first embodiment, a plurality of arms 30 each have a first support position P1 shown in FIG. 14 and a second support position P2 shown in FIG. 15.

In the fourth embodiment, as in the first embodiment, the arm attachment part 21 provided at the upper end part of the mounting supporting post 20 is formed in a regular polygonal shape when viewed from the axial direction of the mounting supporting post 20. The number of sides of the regular polygonal shape of the arm attachment part 21 corresponds to the number of arms 30.

In the fourth embodiment, the rotational axis A3 of each arm 30 that rotates relative to the mounting supporting post 20 is parallel to the axis A2 of the mounting supporting post 20. In FIG. 14 and FIG. 15, the rotational axis A3 of each arm 30 and the axis A2 of the mounting supporting post 20 extend in a direction orthogonal to the plane of the drawing. The rotational axes A3 of the plurality of arms 30 are arranged at equal intervals in the circumferential direction around the axis A2 of the mounting supporting post 20. Thereby, the plurality of arms 30 are arranged at equal intervals in the circumferential direction of the mounting supporting post 20.

Hereinafter, the manner in which the plurality of arms 30 are attached to the mounting supporting post 20 will be described in more detail. The proximal end part of the plurality of arms 30 in the lengthwise direction are each arranged so as to overlap the arm attachment part 21 of the mounting supporting post 20 in the axial direction of the mounting supporting post 20. Each arm 30 is rotatable relative to the arm attachment part 21 around the rotational axis A3 passing through the proximal end part thereof. Each arm 30 extends along the sides of the regular polygon of the arm attachment part 21 while being arranged at the first support position P1 or the second support position P2 (see FIG. 2 and FIG. 4). Here, the plurality of arms 30 are arranged along different sides of the regular polygon in the arm attachment part 21.

The rotational axis A3 of each arm 30 is positioned offset from the middle of a side of the regular polygon of the arm attachment part 21 in a direction along this side. As a result, in each arm 30, when viewed from the axial direction of the mounting supporting post 20, the distances D1, D2 from the axis A2 of the mounting supporting post 20 to the hooks 31 of the arm 30 are not the same at the first support position P1 and the second support position P2.

Specifically, the rotational axis A3 of each arm 30 is positioned offset from the middle of a side of the regular polygonal shape of the arm attachment part 21, in the direction toward the distal end part from the proximal end part of the arm 30 when the arm 30 is arranged at the first support position P1. The amount of offset of the rotational axis A3 of the arm 30 with respect to the axis A2 of the mounting supporting post 20 is the same for all of the plurality of arms 30. As a result, the first distance D1 from the axis A2 of the mounting supporting post 20 to the hook 31 of each arm 30 when the plurality of arms 30 are arranged at the first support position P1 (FIG. 14) becomes longer than the second distance D2 from the axis A2 of the mounting supporting post 20 to the hook 31 of each arm 30 when the plurality of arms 30 are arranged at the second support position P2 (FIG. 15).

According to the drum stand 1F and the drum kit of the fourth embodiment, advantageous effects similar to those of the first embodiment can be achieved.

In the fourth embodiment, as exemplified in FIG. 8, the first hook 31-1 and the second hook 31-2 may be arranged at different positions in the lengthwise direction of the arm 30.

The present disclosure has been described in detail above, however, the present disclosure is not limited to the above embodiments, and various modifications may be made without departing from the scope of the present disclosure.

For example, in the present disclosure, the drum stand may not include the angle adjustment mechanism 5. In other words, the mounting supporting post 20 of the drum mounting part 4 may be directly connected to the stand supporting post 2.

In the present disclosure, at least one arm 30, 30D of the plurality of arms 30, 30D that support a drum DR may be rotatable relative to the mounting supporting post 20 between the first support position P1 and the second support position P2. Even with such a configuration, as in the case of the embodiments described above, the manner in which a drum DR is supported by the drum stand (the diameter of the drum DR to be supported) can be easily switched.

According to the present disclosure, it is possible to provide a drum stand and a drum kit capable of easily switching the manner of supporting a drum.

What is claimed is:

1. A drum stand comprising:
a supporting post; and
a plurality of arms configured to support a drum,
wherein at least one arm, among the plurality of arms, is rotatable relative to the supporting post between a first support position and a second support position,
wherein, at the first support position, the at least one arm extends outwardly relative to the supporting post, and
wherein, at the second support position, the at least one arm extends outwardly relative to the supporting post is configured to support the drum differently from that at the first support position.

2. The drum stand according to claim 1, wherein:
the at least one arm is further rotatable to a storage position, where the at least one arm extends along an axial direction of the supporting post, the storage position being between the first and second support positions, and
the at least one arm is arranged at the first support position by rotating from the storage position in a first rotation direction relative to the supporting post, and is arranged at the second support position by rotating from the storage position in a second rotation direction opposite to the first rotation direction.

3. The drum stand according to claim 2, wherein at least a distal end portion of the at least one arm extending outwardly from the supporting post does not overlap the supporting post in a lengthwise direction of the at least one arm.

4. The drum stand according to claim 2, wherein:
each of the plurality of arms includes a hook at a distal end thereof, and is configured to grip the drum at the first support position and the second support position, and
a first distance from the supporting post to the hook at the first support position is different from a second distance from the supporting post to the hook at the second support position.

5. The drum stand according to claim 4, wherein an axis of rotation of the at least one arm is orthogonal to the axial direction of the supporting post and does not intersect with the axis of the supporting post.

6. The drum stand according to claim 4, wherein:
the hook includes a first hook configured grips the drum at the first support position, and a second hook configured to grip the drum at the second support position, and
the first hook and the second hook are mutually arranged at different positions in the lengthwise direction of the at least one arm so that the first distance and the second distance are different from each other.

7. The drum stand according to claim 2, further comprising:
a first link base movable relative to the supporting post in the axial direction of the supporting post;
a plurality of first arm links that respectively connect the first link base and the plurality of arms;
a second link base movable relative to the supporting post in the axial direction of the supporting post; and
a plurality of second arm links that respectively connect the second link base and the plurality of arms,
wherein each of the plurality of first arm links includes a first end part rotatably attached to one of the plurality of arms, and a second end part rotatably attached to the first link base,
wherein each of the plurality of second arm links includes a first end part rotatably attached to one of the plurality of arms, and a second end part rotatably attached to the second link base,
wherein one arm, among the plurality of arms, is movable to a first rotational position where the one arm and the respective first arm link attached to the one arm are parallel, and
wherein the one arm is movable to a second rotational position where the one arm and the respective second arm link attached to the one arm are parallel, and
wherein the first rotational position and the second rotational position are different from each other.

8. The drum stand according to claim 2, further comprising:
a first link base movable relative to the supporting post in an axial direction of the supporting post;
a plurality of first arm links that respectively connect the first link base and the plurality of arms;
a second link base movable relative to the supporting post in the axial direction of the supporting post; and
a plurality of second arm links that respectively connect the second link base and the plurality of arms,
wherein each of the plurality of first arm links includes a first end part rotatably attached to one of the plurality of arms, and a second end part rotatably attached to the first link base,
wherein each of the plurality of second arm links includes a first end part rotatably attached to one of the plurality of arms, and a second end part rotatably attached to the second link base,
wherein one of the plurality of first arm links and one of the plurality of second arm links are attached to a same one arm of the plurality of arms, and the second end part of the one of the plurality of first arm links and the second end part of the one of the plurality of second arm links are arranged at different positions in a circumferential direction of the supporting post.

9. The drum stand according to claim 1, wherein:
the at least one arm includes:
a first supporting part configured to contact and support the drum at the first support position, and
a second supporting part configured to contact and support the drum at the second support position, and
a characteristic of supporting the drum by the first supporting part is different from a characteristic of supporting the drum by the second support part.

10. A drum kit comprising:
a drum; and
a drum stand comprising:
a supporting post; and
a plurality of arms configured to support the drum,
wherein at least one arm, among the plurality of arms, is rotatable relative to the supporting post between a first support position and a second support position,
wherein, at the first support position, the at least one arm extends outwardly relative to the supporting post, and
wherein, in the second support position, the at least one arm extends outwardly relative to the supporting post is configured to support the drum differently from that at the first support position.
